(19) United States
(12) Patent Application Publication
(10) Pub. No.: US 2004/0062150 A1
(43) Pub. Date: Apr. 1, 2004

(54) Electronic light clock

(76) Inventor: John Neville, Algorta (ES)

Correspondence Address: JOHN NEVILLE, 12ARO 2-1B 12PA, ALGORTA, 48990, ES

(21) Appl. No.: 10/259,302

(22) Filed: Sep. 30, 2002

(51) Int. Cl. G04C 17/02; G04C 19/02

(52) U.S. Cl. 368/240

(57) ABSTRACT

The Electronic Light Clock consists of counting circuits and receives its seconds pulses from crystal oscillator or a quartz. The seconds pulses counted are connected to the load which is an electric bulb

through a transistor, SCR or triac depending on the voltage of bulbs used. The bulbs light one after another. At the completion of 60 seconds, the last pulse of seconds circuit is used as the clock pulse to count 60 minutes using the counting circuit. The same bulbs that indicated the seconds double as minutes indicators.

After the completion of 60 minutes, the hour pulse is used as a clock for the 12 hours counting circuit. Thus the circuit is repeated. The 12 hour pulse is used to trigger another counter which counts the 12 hour signals. The output of this is used as trigger for a digital display circuitry which counts days. The 24 hour output is also counted and used to show months.

Electric and quartz clocks are used world wide. They all have seconds, minutes and hour hands. Time cannot be seen in darkness. Numerical display clocks have the disadvantage of being difficult to read for people suffering from astigmatism and they do not have any attraction. The Electronic Light Clocks use electric bulbs ranging from 6V to 220V to show seconds minutes and hours. Decorative bulbs can be used and the relay of light from one second bulb to another is very engaging.

The minutes and hour bulbs make the display of time all the more attractive. These clocks can play a therapeutic role in hospital wards, clinics, waiting rooms, and bedrooms not to mention the sitting rooms and outdoors.

This invention, the Electronic Light Clock, has no movable parts and all the integrated circuits, located in their sockets, and the bulbs can be replaced by the user using the simple instructions provided.

When the clock is switched on the 12 hour bulb lights up and the seconds bulbs begin their cycle of marking seconds. On the completion of 60 second count the first minute bulb lights. After the completion of 60 minutes the hour bulb indicating one switches on. Thus seconds, minutes and hours are counted. There are 60 second bulbs which also substitute for minutes because the minute bulb stays lit while the second bulbs are lighting around in a circle. The inner circle of 12 bulbs are dedicated for hours while the outer concentric circle has 60 second and minute bulbs. The centre of

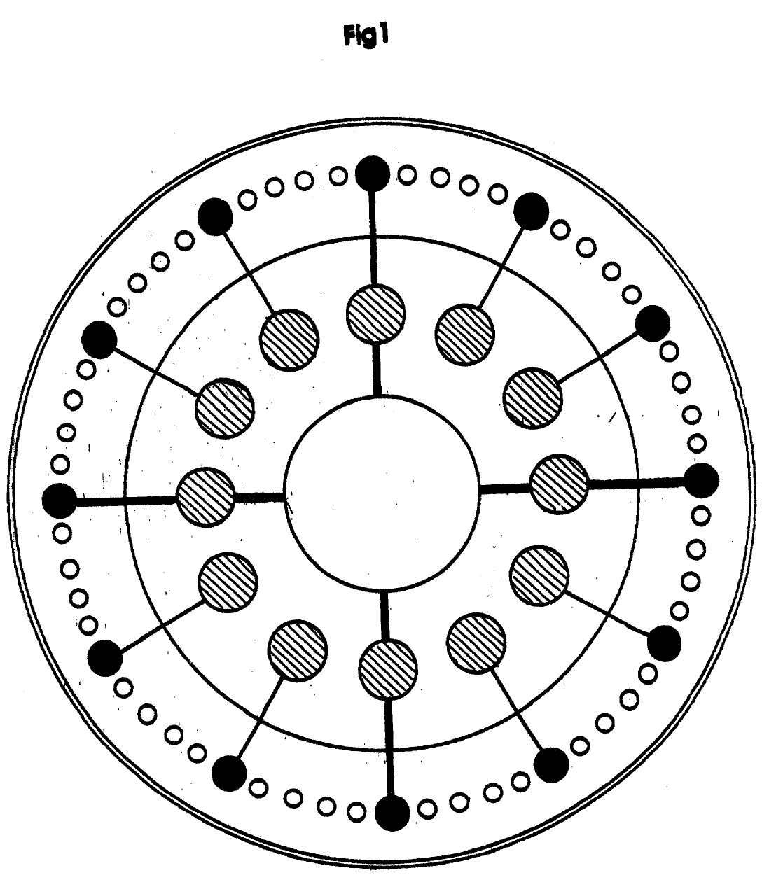

the inner circle in FIG. 1 is used to show a painting, a picture or day and month, etc.

The Seconds Counting Circuit

The seconds signal is produced using a crystal or quartz in combination with counting circuitry. The seconds output goes to AND Gates. Each AND gate gets its second output from the Seconds Programmer which is a 5-stage Johnson counter. When the clock is switched on, the seconds programming circuit's output from digit zero is high. This output is ANDed with the 1 second signal in the AND gate and applied to the clock of first Johnson counter. This IC counts 9 seconds. Each output drives its respective transistors whose loads are the bulbs indicating seconds and minutes on the dial. The 9th second Q9 besides driving the load also serves as a clock pulse for the Seconds Programmer SP which is programmed to count at the falling edge of the pulse. The SP advances by one. The changed output of SP enables the AND gate whose output is connected to clock of the next Johnson counter. It counts to 9 and the above process is repeated. The successive ICs count in turn until 60.

The last Johnson counter counts only 6. The Q6 output lights the 60th bulb and also resets the SP.

The Minutes Counting Circuit

The Q6 output of the last seconds counter now becomes the signal pulse for the set of minutes counting ICs The minutes are counted identically as the seconds except for the fact that it obtains the 1 min. clock pulses from the last Q6 of the seconds Johnson counter and the second input to be ANDed comes from the Minutes Programmer MP. MP functions like the SP and provides the succeeding outputs each of which is ANDed to produce the enabling output. All the outputs of the seconds ICs pass through diodes as well as the outputs of the minutes 5-stage Johnson counters. The ends of each couple of diodes from every Q of the seconds and minutes ICs are joined and soldered to the bases of their respective transistor which is triggered by the seconds' as well as the minutes' pulses arriving from the Qs of the seconds and minutes lCs.

The Hours Counting Circuit

The 2 Johnson counters that together count 12, get their signal pulses from the Q6 of the last minutes counter. They are one hour pulses. Before being applied to the clock input of hour counter the 60 minute signal is ANDed with the signal from the Hour Programmer which is at Qo, and used as a clock pulse to count the hours. After the first Johnson counter has counted 9 the Q9 output drives the transistor whose load is the hour bulb besides triggering the Hour Programmer IC HP at the falling edge.

The IC HP advances by one thus enabling the AND gate connected to the clock of the next IC to start counting the arriving hour pulses. After 3 counts (hours) the Hour Programmer is reset.

Thus the cycles of seconds, minutes and hours are repeated over and over again. The hour circuits can be used to indicate date, day and month in many interesting ways. But the principle used is the same with adjustments for 28, 29, 30, 31 days.

The switches M and N are connected to the seconds output and used to trigger the seconds and minutes circuits to correct or set the minutes and hours of the clock in the event of the failure of the remote control system. The clock has a signal decoder circuitry which receives signals from the remote control to switch on, to reset, and set the right time in minutes and hours. The power to the bulbs is controlled by a dimmer circuit which is operated by remote control as well as manually by controlling the voltage through the adapter which can be used with 120 to 240V AC.

1 the electronic light clock whose schematic is being submitted is the first attempt ever to display time by the relay of light from one second to the next until 60 seconds are completed and later minutes and hours using electric bulbs ranging from 3 to 220 volts.

2 Setting manual switches or remote control is used by the addition of coding and decoding ICs along with the counting circuit to produce 3 distinct outputs to switch on the clock or correct the time or reset the clock.
